(19) United States
(12) Patent Application Publication
(10) Pub. No.: US 2003/0204981 A1
(43) Pub. Date: Nov. 6, 2003

(54) Apparatus and method for delivering motivational or instructional message/reminder

(76) Inventors: Robert H. Boling III, Las Vegas, NV (US); Richard M. Melchiorre, Las Vegas, NV (US)

Correspondence Address: WEISS & MOY PC, 4204 NORTH BROWN AVENUE, SCOTTSDALE, AZ, 85251, US

(21) Appl. No.: 10/141,330

(22) Filed: May 6, 2002

(51) Int. Cl. G09F 3/12; G09F 3/10

(52) U.S. Cl. 40/668; 40/299.01

(57) ABSTRACT

An apparatus and method for delivering an instructional or motivational message to a person engaged in an activity requiring skill. The message is displayed on the upper surface of a message carrier, which is removably coupled to a message base, which in turn is attached to an article. The article can be a shirt, hat, golf club grip, golf club head cover, hat-clip, or other desired surface. It is preferred to provide more than one article, and to provide a message carrier that may be interchangeably inserted into more than one base.

### FIELD OF THE INVENTION

This invention relates generally to the delivery or provision of motivational or instructional messages/reminders, and, more particularly, to an apparatus and method for delivering such a message/reminder in a convenient manner and in a manner that permits variation of the message delivered.

### BACKGROUND OF THE INVENTION

In a variety of different situations, it is desired to provide a motivational or instructional message/reminder that may be readily viewed by a person involved in a situation where the message is most needed. (The terms instructional and reminder are used interchangeably throughout, and each is intended to include messages that instruct or teach through the relation of information as well as messages that remind the recipient of desired information.) For example, golfers are often benefited from exposure to such messages. Typical golf messages include “get it to the hole,” “stay behind the ball,” “keep your head down,” “complete backswing,” and the like.

However, while a golfer may read such messages before or after a round of golf, or may happen to hear the message on an occasional basis from a playing partner during a round, an apparatus and method is needed that will reliably deliver the desired message to the golfer when most needed—i.e., during play. The apparatus and method should be discrete, so as not to draw unwanted attention to the delivery of the message or its content. It should also be variable, so that the golfer can change the message as desired. Finally, it should be noted that the play of golf is only one example of a situation in which a person may wish to have access to an instructional and/or motivational message. There are myriad other situations where such access may be desired, such as during the play of other sports, public speaking, construction projects, or indeed virtually any situation requiring a person to perform a skill in a particular manner—and the apparatus and method should be useable in these situations as well. The present invention satisfies these needs, and provides other, related, advantages.

### SUMMARY OF THE INVENTION

It is an object of the present invention to provide an apparatus and method for delivering a motivational or instructional message to a person performing an activity requiring skill, such as playing golf.

It is a further object of the present invention to provide an apparatus and method for delivering a motivational or instructional message to a person performing an activity requiring skill, which is discrete.

It is a still further object of the present invention to provide an apparatus and method for delivering a motivational or instructional message to a person performing an activity requiring skill, which allows the variation of the message delivered.

### BRIEF DESCRIPTION OF THE PREFERRED EMBODIMENTS

In accordance with one embodiment of the present invention, an apparatus for delivering a message is disclosed. The apparatus comprises, in combination: a message carrier; one of an instructional and a motivational message located on an exposed upper surface of the message carrier; at least one message base secured to at least one article; and means for removably coupling the message carrier to the message base so that the message may still be viewed following the coupling.

In accordance with another embodiment of the present invention, a method for delivering a message is disclosed. The message comprises the steps of: providing a message carrier; providing one of an instructional and a motivational message on an exposed upper surface of the message carrier; providing at least one message base secured to at least one article; providing means for removably coupling the message carrier to the message base so that the message may still be viewed following the coupling; and coupling the message carrier to the message base.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1A is a top view of an embodiment of the message delivery apparatus of the present invention, illustrating a button-snap style for the message carrier.

FIG. 1B is a front view of an embodiment of the message delivery apparatus of the present invention, which is adapted to be inserted into the upper portion of a golf club grip.

FIG. 1C is a front view of another embodiment of the message delivery apparatus of the present invention, which is adapted to be inserted into the upper portion of a golf club grip.

FIG. 1D is a front view of a standard, iron-type golf club.

FIG. 2 is a bottom view of an embodiment of the message delivery apparatus of the present invention, shown in position on the underside of the bill of a baseball-type hat.

FIG. 3 is a front view of an embodiment of the message delivery apparatus of the present invention, shown in position on a shirt sleeve.

FIG. 4 is a perspective view of another embodiment of the message delivery apparatus of the present invention, positioned on a golf club head cover.

FIG. 5 is a side view of another embodiment of the message delivery apparatus of the present invention, wherein the message carrier is snap-style, the base is a money-type clip (referred to herein as a “hat-clip”), and the clip is coupled to the bill of a baseball-style hat.

FIG. 6 is A front view of an embodiment of the message delivery apparatus of FIG. 3, with the message carrier being shown removed and with the message base exposed.

FIG. 7 is a perspective view of a snap-type message carrier and message base.

FIG. 8A is a top view of an embodiment of a hat clip.

FIG. 8B is a bottom view of an embodiment of a hat clip.

FIG. 8C is a bottom view of another embodiment of a hat clip.

FIG. 8D is a top view of an embodiment of a hat clip in position on a hat.

### DETAILED DESCRIPTION OF THE PREFERRED EMBODIMENTS

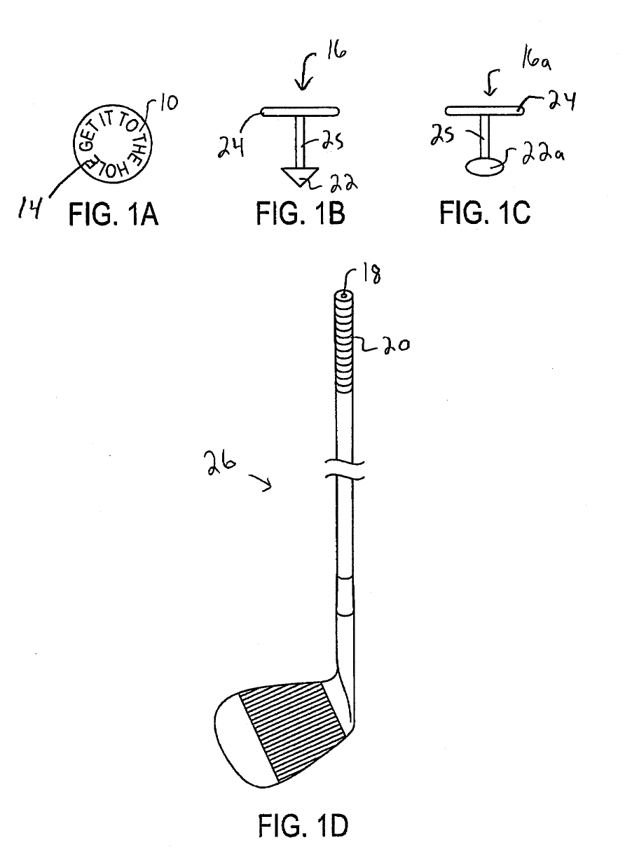

Referring first to FIGS. 1A, 2-4, 6 and 7, the basic components of the present invention consist of a message carrier 10 and a message base 12. Preferably, the message carrier 10 and message base 12 comprise, respectively, male and female portions of a snap-type assembly (see specifically FIG. 7). (It should be noted that other coupling means, such as hook and loop, magnets, patches, pins, etc. may be substituted for the snap-type assembly—with the message carrier 10 and message base 12 having corresponding mating portions of such coupling means, or with the message base 12 being dispensed with for those means (e.g., patches and pins) that would not require a base.)

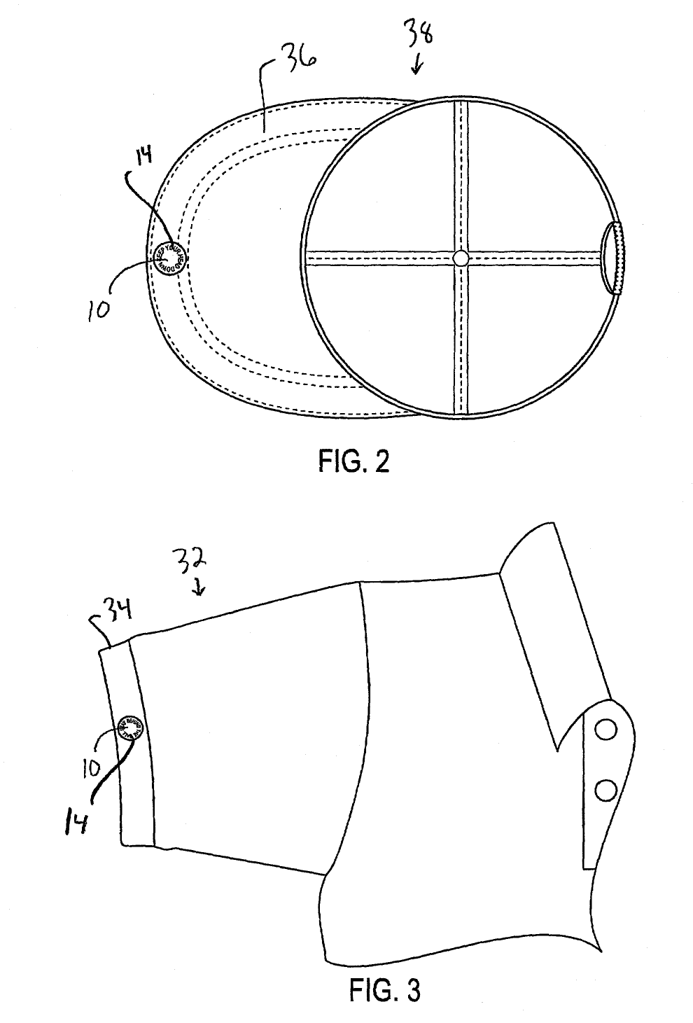

Turning first to the message carrier 10, it has located on an exposed upper surface thereof a message 14. The message 14 should preferably be instructional (with the term “instructional” being defined to include a reminder-type message) or motivational. FIG. 1A shows an example of a motivational message 14: “Get it to the hole”. FIGS. 2, 3, 4, and 6 show examples of instructional (or reminder-type) messages, respectively: “keep your head down”; “stay behind the ball”; “rhythm tempo”; and “complete backswing.” These are golf-related messages.

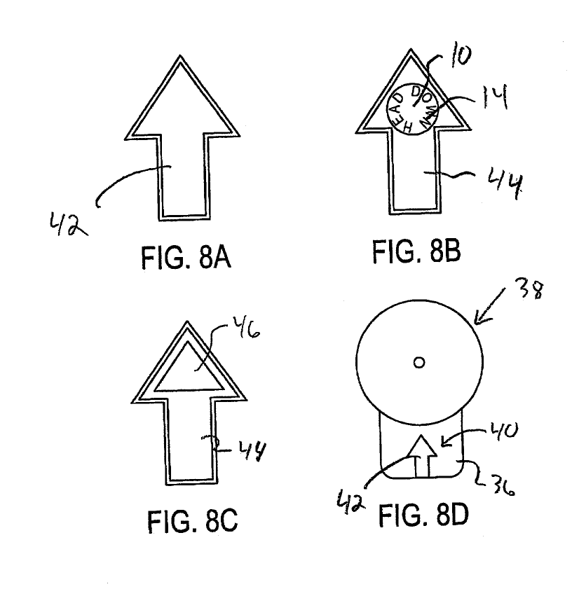

Of course, by no means should the messages 14 shown in FIGS. 1A, 2-4 and 6 be regarded as a comprehensive list of such messages for golf, and a virtually infinite variety of suitable messages is possible. A message 14 can be a well-established message such as “get it to the hole,” or a less known message. It is also possible for a user to create his or her own personal message 14, containing whatever expression a particular individual finds motivational or instructional. (In this regard, it may be desired to provide a message carrier 10 having a surface, such as a dry-erase surface, upon which a user can write his or her own personal message 14. See FIG. 8C, discussed below). Still further, it would be possible to create a teaching system based on the use of a particular series of messages, displayed in particular places (as discussed by way of example herein) at particular times (e.g., depending on the number of rounds played following commencement of the system, during a round of play, depending on where the player is playing (driving range or golf course)).

Moreover, it should be understood that the content of the message 14 can be customized, as necessary, depending on the skill-requiring activity to be performed. For example, a person giving a public speech might desire a message 14 that says “maintain eye contact,” “talk slowly,” or the like. A person playing tennis might desire a message 14 that says “get first serve in,” or the like. It should be apparent that there is a large variety of skill-requiring activities, in the performance of which a person could benefit from exposure to a suitable motivational or instructional message 14. The present invention is directed to any such activity, with golf (and the other activities mentioned herein) representing only examples.

The lower surface of the message carrier 10 features the male portion of a snap assembly (or one portion of another two-part coupling assembly, such as hook or loop material). That male portion will couple to a corresponding female receptacle on a message base 12.

It is desired that the message carrier 10, and in particular the male portion thereof, be provided of one size without regard to where it is ultimately to be placed. Similarly, it is desired that the female receptacle on the message base 12 also be provided of one size. In this manner, interchangeability of message carriers 10 and message bases 12 is achieved. Thus, a particular message 14 located on a particular message carrier 10 could be optionally positioned on a message base 12 located on a golf club grip(utilizing a club tip as described herein), hat bill, sleeve, golf club head cover, or other location. In this regard, a user may wish to rotate different messages 14, or to alter their locations periodically for purposes of determining which location is most preferred. By making these component portions uniform, the feature of interchangeability is achieved.

Of course, without departing from the spirit or scope of the present invention, it would be possible to provide different sizes of message carriers 10 and message bases 12, so that certain message carriers 10 only fit into certain message bases 12, and so that there is either no interchangeability or only partial interchangeability.

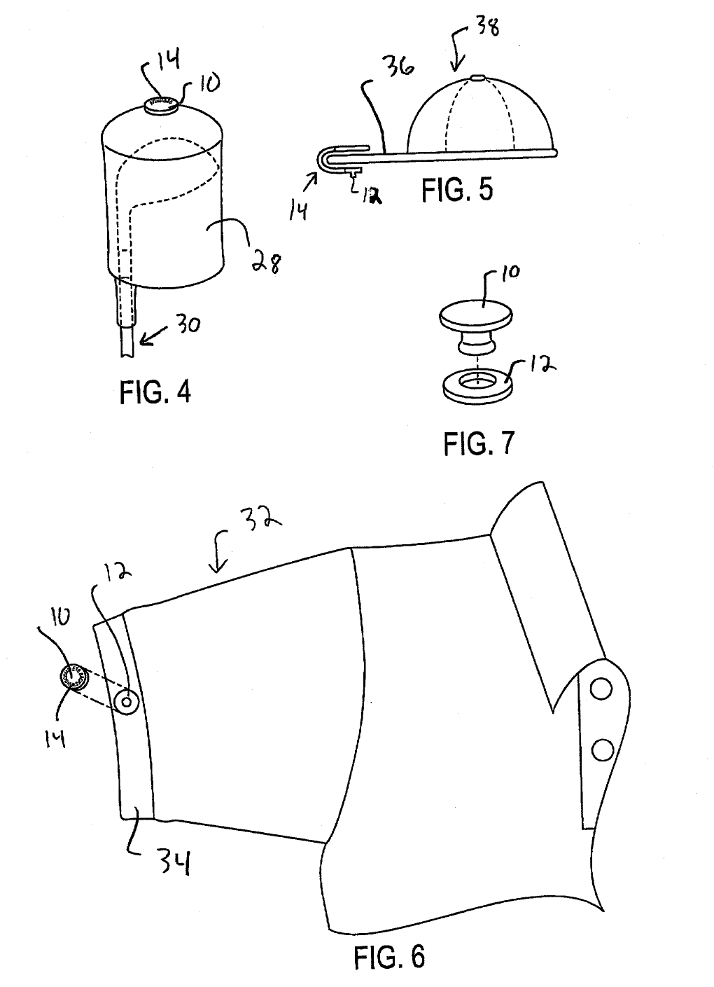

There are numerous potential locations for a message base 12. These include, but are not limited to: (a) the butt end of a golf grip(see FIGS. 1B-D); (b) the underside of the bill of a baseball-type hat (see FIGS. 2, 5, and 8A-8D); (c) apparel (including by way of example a shirt sleeve (see FIGS. 3 and 6)); and (d) on a golf club head cover (see FIG. 4). These will now be discussed in greater detail.

Attention is first drawn to FIGS. 1B-1D. FIG. 1B illustrates one embodiment of a club tip 16, while FIG. 1C illustrates a second embodiment of a club tip 16a. The club tip 16 or 16a is adapted to be inserted into the opening 18 at the butt end of a golf grip 20, with the expanded area 22 or 22a being dimensioned so that it may be inserted through the opening 18. The underside of the horizontal surface 24 will then contact the end of the golf grip 20. A message base 12 (not shown) will be coupled to the upper surface of the horizontal surface 24. The shaft 25 joining the expanded area 22 or 22a and the horizontal surface 24 should have a length sufficient to permit the expanded area 22/22a to pass just through the opening 18 when the horizontal surface 24 contacts the end of the golf grip 20, with the expanded area 22/22a resisting passage back through the opening 18 without the application of pulling force. In this fashion, the fit will be snug. This is necessary so that the club tip 16/16a will resist detachment from the golf club 26 during the removal or insertion of the golf club 26 from or into the golf bag (not shown), or during swinging of the golf club 26 and contacting of a golf ball (not shown) with the golf club 26.

Referring now to FIG. 4, another embodiment of the present invention is shown. In this embodiment, the message carrier 10 with a message 14 thereon is shown in position on a message base 12 (not shown), which message base 12 is coupled to a golf club head cover 28 covering a golf club 30. In this configuration, a player who is about to use golf club 30 will be exposed to message 14 immediately before removing the head cover 28 and using the golf club 30.

Referring now to FIGS. 3 and 6, another embodiment of the present invention is shown. In this embodiment, the message carrier 10 with a message 14 thereon is shown in position on, and removed from, a message base 12. In this embodiment, the message base 12 is located on the end of shirt sleeve 32, preferably on the trim portion 34. In this configuration, a player can be expected to see the message 14 as he or she is about to initiate a golf swing. While FIGS. 3 and 6 show a shirt, it should be understood that this is merely one example of a piece of apparel that may have a message carrier 10 and message base 12 positioned thereon. Other types of apparel suitable for use with the present invention would include, but not be limited to, wristbands, jackets, wind-breakers, sweaters, gloves, ties, etc.

Referring now to FIG. 2, another embodiment of the present invention is shown. In this embodiment, the message carrier 10 with a message 14 thereon is shown in position on a message base 12 (not shown) located on the underside of the bill 36 of a baseball-type hat 38. In this configuration, the positioning of the message 14 is particularly discrete, and will not draw undue attention. A player will notice the message carrier 10 during play, and will either recall the message 14 or can focus more specifically on the message carrier 10 in order to read the message 14. (While a baseball-style hat is shown by way of example, it should be understood that other styles of hats could also be utilized, including golf hats, visors, helmets, etc.) In FIGS. 5 and 8A-8D, embodiments are shown, again related to the positioning of a message 14 on the underside of a bill 36 of a baseball-type hat 38. In this configuration, the message carrier 10 is positioned on a message base 12, which message base 12 is itself located on a hat-clip 40. The hat-clip 40 is then slipped over an end of the bill 36, with the message 14 being displayed downward, as shown in FIG. 5. One advantage of this embodiment is that the hat-clip 40 can be removed from one hat 38, and positioned on a second hat 38. Moreover, this embodiment also permits a person to utilize the present invention with essentially any prior art hat 38, and specifically with one that does not have a message base 12 secured thereon.

Referring specifically to FIGS. 8A-8D, it may be desired to configure the top clip element 42 and bottom clip element 44 as arrows, with the head of the arrow pointing in the direction of the head of the wearer. As shown in FIG. 8B, bottom clip element 44 may have a snap-type message carrier 10 with a message 14 thereon, inserted into a message base 12 (not shown). Alternatively, as shown by way of example in FIG. 8C, the bottom clip element may have a dry-erase or other writing surface 46, upon which a message 14 (not shown) can be created by the user with a marker or the like.

Preferably, a user will have a plurality of articles shown by way of example herein—including a shirt (FIG. 6), hat (FIGS. 2, 5, and 8D), club head cover (FIG. 4), and/or golf club (FIGS. 1A-D)—with a message base 12 thereon. This will enable a user to position certain messages 14 on certain specific articles. Alternatively, a user may wish to position the same message 14 on more than one article, so as to increase exposure to that message 14. Still further, a user could vary a message 14 from article to article, as desired.

While the invention has been particularly shown and described with reference to preferred embodiments thereof, it will be understood by those skilled in the art that the foregoing and other changes in form and details may be made therein without departing from the spirit and scope of the invention.

I claim:

1. An apparatus for delivering a message comprising, in combination:
a message carrier;
one of an instructional and a motivational message located on an exposed upper surface of said message carrier;
at least one message base secured to at least one article; and
means for removably coupling said message carrier to said message base so that said message may still be viewed following said coupling.

2. The apparatus of claim 1 further comprising a plurality of message bases adapted to interchangeably receive a single message carrier.

3. The apparatus of claim 1 wherein said article is a shirt.

4. The apparatus of claim 3 wherein said message base is located on a trim portion of a sleeve of said shirt.

5. The apparatus of claim 1 wherein said article is a golf club head cover.

6. The apparatus of claim 1 wherein said article is a hat.

7. The apparatus of claim 6 wherein said message base is located on an underside of a bill portion of said hat.

8. The apparatus of claim 1 wherein said apparatus is a hat-clip.

9. The apparatus of claim 1 wherein said apparatus is a golf club grip.

10. The apparatus of claim 1 wherein said means comprises a snap type assembly.

11. The apparatus of claim 1 further comprising a club tip insertable into an opening in an upper portion of a golf club grip and adapted to receive at an upper portion thereof a message base.

12. The apparatus of claim 11 wherein said club tip comprises an expanded area dimensioned to be inserted through said opening, a horizontal surface dimensioned to contact said upper portion of said golf club grip but not to pass through said opening, and a shaft joining said expanded area and said horizontal surface.

13. The apparatus of claim 1 comprising at least two said articles, each having at least one said message base located thereon.

14. A method for delivering a message comprising the steps of:
providing a message carrier;
providing one of an instructional and a motivational message on an exposed upper surface of said message carrier;
providing at least one message base secured to at least one article;
providing means for removably coupling said message carrier to said message base so that said message may still be viewed following said coupling; and
coupling said message carrier to said message base.

15. The method of claim 14 further comprising the step of providing at least two said articles, each having at least one said message base located thereon.

16. The method of claim 15 wherein said at least two said articles are selected from the group including a hat, a shirt, a golf club, a golf club head cover, and a hat-clip.

17. The method of claim 14 wherein said means comprises a snap type assembly.

18. The method of claim 14 further comprising the step of providing a club tip invertible into an opening in an upper portion of a golf club grip and adapted to receive at an upper portion thereof a message base.

19. The method of claim 18 wherein said club tip comprises an expanded area dimensioned to be inserted through said opening, a horizontal surface dimensioned to contact said upper portion of said golf club grip but not to pass through said opening, and a shaft joining said expanded area and said horizontal surface.
